(19) United States
(12) Patent Application Publication
(10) Pub. No.: US 2017/0330476 A1
(43) Pub. Date: Nov. 16, 2017

(54) MOBILE EDUCATION PLATFORM

(71) Applicant: NSCI Group, Inc., Washington Crossing, PA (US)

(72) Inventor: Robert M. Bieber, Washington Crossing, PA (US)

(73) Assignee: NSCI Group, Inc., Washington Crossing, PA (US)

(21) Appl. No.: 15/593,098

(22) Filed: May 11, 2017

Related U.S. Application Data
(60) Provisional application No. 62/335,586, filed on May 12, 2016.

(51) Int. Cl. G09B 7/08; G09B 19/00; G09B 5/06

(52) U.S. Cl. CPC G09B 7/08; G09B 5/065; G09B 19/00

(57) ABSTRACT

A system and method for accruing credits to satisfy continuing education requirements with the accrual occurring by banking earned credits until a threshold of credits is met are disclosed. The system and method include a plurality of curricula divided into one or more segments, a plurality of learning objectives associated with each of the segments and being directed to one of the plurality of learning objectives, at least one survey corresponding to each of the plurality of learning objectives used to verify the completion of the at least one segment and fulfillment of the corresponding learning objective, a banking system for capturing the earned credit based on completed segments, the banking system accruing the earned credit until a minimum threshold of credit is met, and a credit system that seeks credit for the accrued earned credit by transmitting a request for credit to the appropriate certification organization.

### CROSS REFERENCE TO RELATED APPLICATION

This application claims the benefit of U.S. Provisional Application No. 62/335,586 filed May 12, 2016, which is incorporated by reference as if fully set forth.

### FIELD OF INVENTION

The present invention relates to a mobile education platform, and more particularly, to a mobile education platform that partitions a program of some length into shorter modules.

### BACKGROUND

In our new mobile world, people are on the go while having access to multiple different electronic devices. The electronic devices provide people with connectivity. This connectivity can be used to shop online and watch programming and also provides people the ability to learn subject matter. Coupling this access with the need in many professions to perform a certain amount of continuing learning over a certain time period, like 12 credit hours of continuing learning over each year, for example, creates an opportunity to use this time to earn continuing learning credits.

While access is easy for people while on the move, attention can often be limited and/or time may be available in finite small chunks, such as tens of minutes, for example. Available learning programs fail to provide the ability to view for credit in quantized time periods that compare with the amount of time people can free-up. Often educational programs are not configured and/or do not allow credit to be accrued in small time increments. Therefore, a need exists for education programs that can be viewed and credit provided in quantized periods of time, while ensuring that learning goals are being achieved.

### SUMMARY

A system and method for accruing credits to satisfy continuing education requirements with the accrual occurring by banking earned credits until a threshold of credits is met are disclosed. The system and method include a plurality of curricula that are viewed to earn continuing education credits, each of the plurality of curricula having a defined credit value associated therewith and each of the plurality of curricula being divided into one or more segments, each of the segments corresponding to a partial level of credit, a plurality of learning objectives associated with each of the plurality of curricula with each of the one or more segments being directed to one of the plurality of learning objectives, at least one survey corresponding to each of the plurality of learning objectives, the at least one survey being completed by user after the user views at least one segment directed to the corresponding learning objective in order to verify the completion of the at least one segment and fulfillment of the corresponding learning objective and award the earned credit corresponding to the partial level of credit corresponding to the viewed segment, a banking system for capturing the earned credit based on completed segments, the banking system accruing the earned credit until a minimum threshold of credit is met, and a credit system that once the threshold is met seeks credit for the accrued earned credit by transmitting a request for credit to the appropriate certification organization to award the earned credit to the user.

### BRIEF DESCRIPTION OF THE DRAWINGS

A more detailed understanding may be had from the following description, given by way of example in conjunction with the accompanying drawings wherein:

FIG. 1 illustrates a system diagram of a continuing education system of the present invention;

FIG. 2 illustrates a method of determining when to award credits within the system of FIG. 1;

FIG. 3, referring to the collective of FIGS. 3A and 3B, illustrates a method of earning credits under the rules of FIG. 2 within the system of FIG. 1;

FIG. 4 illustrates a window by which a user utilizes the present invention to choose an educational program to view;

FIG. 5 illustrates a window that presents the user with the “front matter,” the material that describes the educational program and the requirements for completion;

FIG. 6 illustrates a window provided to the user prior to viewing the module;

FIG. 7 illustrates a window provided to the user after viewing the module;

FIG. 8 illustrates a window that allows the user to interact with the banking system;

FIG. 9 illustrates a window indicating that the user needs to complete the survey;

FIG. 10 illustrates a window that is presented to the user based on the modules viewed;

FIG. 11 illustrates a window depicting the certificate;

FIG. 12 illustrates a window displaying the selected modules within the program by providing information regarding viewed modules and credited modules;

FIG. 13 illustrates a window updated from the window of FIG. 12 once the quiz question response has been submitted;

FIG. 14 illustrates a window that depicts the banking system discussed above with respect to FIG. 8;

FIG. 15 illustrates a window updated from the window of FIG. 10 that allows the user to interact with the banking system; and

FIG. 16 illustrates a window depicting the updated certificate of the window of FIG. 11.

### DETAILED DESCRIPTION

A mobile education platform may be used to obtain continuing education (CE) credits associated with professional accredited organizations. CE credits may include, but are not limited to, for example, continuing medical education (CME) credits and continuing legal education (CLE) credits. The mobile education platform may also be used for unaccredited programs.

The mobile education platform may partition a program that may be an hour or longer into shorter modules of five minutes each or less. In certain circumstances, a module may be longer than five minutes.

A user may complete a brief test after completing each module. The time for each module may be banked until the user accumulates sufficient time to earn the CE credit.

When the user banks enough time to earn the CE credit, the platform automatically sends a CE credit complete message to the appropriate CE accreditation authority. In response to the CE credit complete message, the mobile education platform receives a certificate of completion and forwards it to the user, the crediting agency, such as the accreditation authority, for example, or both.

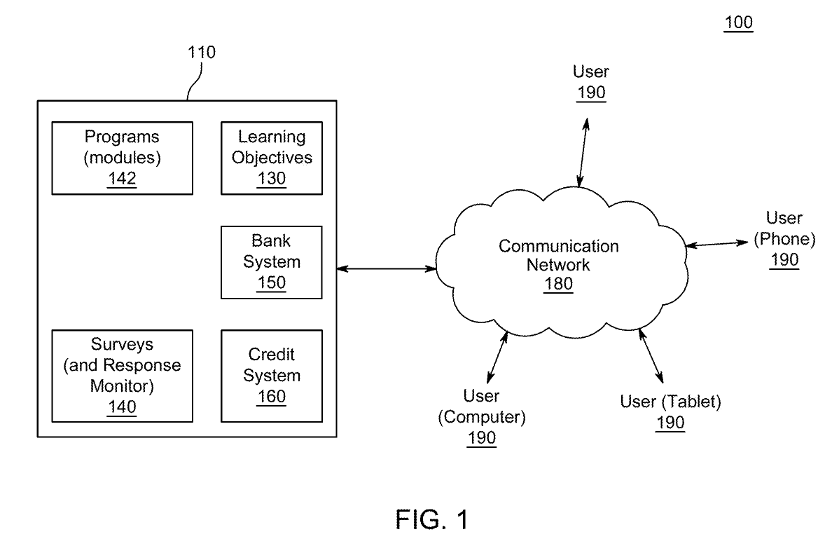

FIG. 1 illustrates a system diagram 100 including a continuing education system 110 of the present invention. The continuing education system 110 includes curricula 120, or programs, divided into discrete modules, a series of learning objectives 130 that may be related to ones of the discrete modules of the programs 120, a plurality of assessments 140, or surveys, associated with ones of the learning objectives 130 and ones of the discrete modules of the programs 120, a bank system 150 and a credit system 160. System 100 also includes a communication network 180 and a plurality of users 190.

Continuing education system 110 allows for accruing credit to satisfy continuing education requirements. The accrual of credit occurs by banking earned credit until a threshold of credit is met. The system 110 includes a plurality of curricula 120 that are viewed to earn continuing education credits with each of the plurality of programs having a defined credit value associated therewith and each of the plurality of programs being divided into one or more modules with each of the modules corresponding to a partial level of credit. The system 110 includes a plurality of learning objectives 130 associated with each of the plurality of curricula 120 with each of the one or more modules being directed to one of the plurality of learning objectives 130. The system includes at least one survey 140 corresponding to each of the plurality of learning objectives 130 with the at least one survey 140 being completed by user after the user views at least one module of the program 120 directed to the corresponding learning objective 130 in order to verify the completion of the at least one module of the program 120. The survey 140 once completed by the user evidences fulfillment of the corresponding learning objective 130 allowing the system 110 to award the earned credit corresponding to the partial degree or level of credit corresponding to the viewed module of the program 120. Banking system 150 captures the earned credit based on completed modules of the program 120 with banking system 150 accruing the earned credit until a minimum threshold of credit is met. Credit system 160 is initiated once the threshold is met and seeks credit for the accrued earned credit by transmitting a request for credit to the appropriate certification or accreditation organization in order to award the earned credit to the user.

The communication network 180 may be wired and/or wireless and may be public, private or a combination of public or private networks.

Plurality of users 190 may be from any industry that requires continuing learning credits. This may include accountants, doctors, lawyers, nurses, paralegals, psychologists, physician assistants, social workers and other similarly accredited professions. Other types of users 190 include users who require additional courses or accreditation, such as users who are bound to take continuing courses in order to maintain certifications, for example.

Plurality of users 190 may access the continuing education system 110 via the communication network 180. This access may utilize an access device, such as a desktop or portable computer, tablet computer, smartphone, television or other means. The access device may include an interface for communicating via the communication network 180, a monitor or screen for presenting information to one of the plurality of users 190, a processor, and an interface for the one of the plurality of users 190 to provide input, such as a mouse, keyboard, or other input device.

Access to the continuing education system 110 may be through a login/password using a web browser, a desktop application, or a mobile application. Access may also include linking via short message service (SMS) or social media. By accessing the continuing education system 110, one of the plurality of users 190 may be provided access to the curricula 120 available within the continuing education system 110. Such access may include viewing live programs, web-casted programs, archived programs and downloading MP3 programs, by way of non-limiting example only.

Curricula 120 may include any presentation of subject matter that is accredited for a profession. The programs may be live or recorded, and may be provided in MP3, .wav, or other storage means, and streamed either live or pre-recorded. In an implementation related to accredited CE, learning objectives may be met by the content of the programs. There may be a defined set of learning objectives 130 for each program. Each program 120 may be divided into distinct modules. The modules are each linked to a learning objective 130. The duration of modules may vary, but may be from one minute to five minutes, or even up to ten minutes, for example.

Series of learning objectives 130 may be configured for each of the programs 120. These learning objectives 130 may be the purpose of the program 120, for example. Each learning objective of the series of learning objectives 130 may be mapped to multiple modules within the program 120. Each of the modules in the program 120 is mapped to a single learning objective of the series of learning objectives 130.

Plurality of assessments 140 may be stored within a database within continuing education system 110 or may be stored external to continuing education system 110 and accessible thereto. Plurality of assessments 140 may enable the creation of a survey 140 directed to ones of the learning objectives 130 and ones of the discrete modules of the programs 120. A unique survey 140 may be created for each program. As described herein, questions centered on the learning objectives 130 may be created and a survey 140 built from the questions.

Banking system 150 is configured to capture the earned credit based on completed modules of the program 120. The completed modules of the program 120 being defined by the completion of the survey 140 and validation of the appropriate associated learning objective 130. Banking system 150 accrues the earned credit until a minimum threshold of credit is met. The minimum threshold of credit may be determined by the minimum level of credit that may be applied for with respect to a program 120 via an accreditation organization.

Credit system 160 seeks credit for the accrued earned credit by transmitting a request for credit to the appropriate accreditation organization to award the earned credit to the user. The CE credits are awarded based on the length of the content or time a user spends on a program 120. Credit system 160 may be initiated once the threshold of the minimum level of awardable credits is achieved by a user on a program 120.

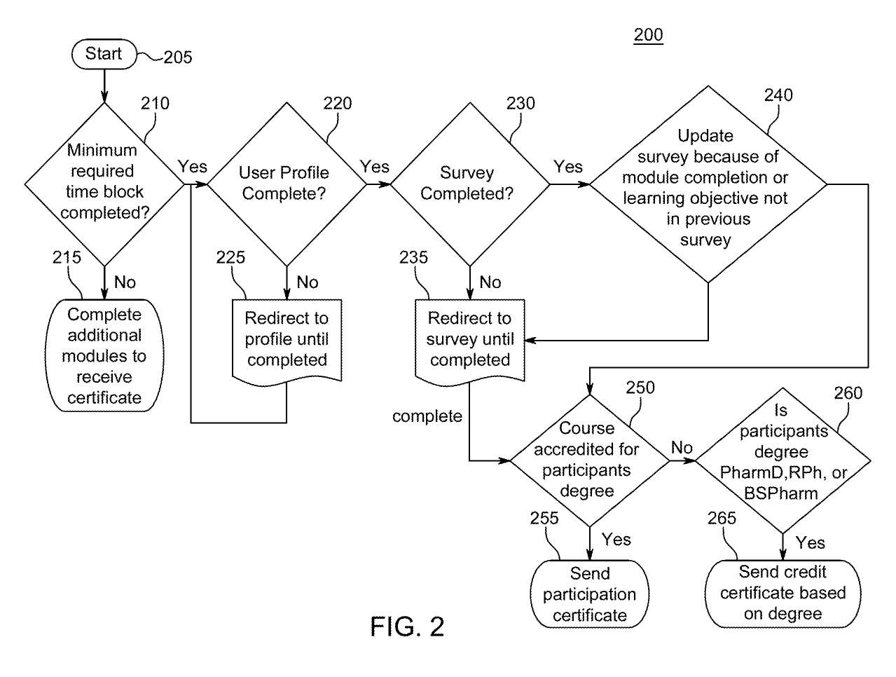

FIG. 2 illustrates a method 200 of determining when to award credits within the system of FIG. 1. Method 200 may be performed within credit system 160 of FIG. 1. Method 200 is initiated at a starting point 205. At step 210, a query by the banking system is performed to determine whether the minimum required time block has been completed. If the query of step 210 is negative, additional modules must be completed to receive a certificate at step 215. If the query of step 210 is affirmative, method 200 progresses to step 220 where it is determined by the banking system if the user profile has been completed. If the query of step 220 is negative, method 200 may be redirected to complete the user profile at step 225 until the user profile is completed. If the query of step 220 is affirmative, method 200 progresses to the banking system determining at step 230 if the survey has been completed. If the query of step 230 is negative, method 200 may be redirected to the survey until the survey is completed. If the query of step 230 is affirmative, method 200 may update the survey if the module completion or learning objective is not in the previous survey at step 240.

Once the survey is updated at step 240, method 200 loops about determining if the survey is completed at step 230 until complete, or if not, updates at step 240. The method then proceeds to step 250, where once the survey is complete, the credit system determines if the course is accredited for the participant's degree. If the query of step 250 is answered in the affirmative, method 200 proceeds to send from the credit system the participation certificate at step 255. If the query at step 250 is negative, method 200 proceeds to query if participant's degree is PharmD, RPh, or BSPharm at step 260. Other degrees may also be includes, such as, APN, BSN, Clinical Nurse Specialist, CNP, DO, LPN, LVN, MBBS, MD, MSN, NP, PA, PhD/ND/EdD, RD, RDN, and RN, by way of non-exclusive examples only. If the query of step 260 is answered in the affirmative, method 200 proceeds to send from the credit system the credit certificate based on the degree at step 265. In the specific situation where the user has a pharmacy degree, such as RPh, PharmD, BSPharm, the completion may be tracked by a central accrediting body, such as the ACPE, for example. In such a situation, instead of providing a certificate to the user, system 100 may communicate directly with the accrediting body to submit completed credits by the users. In such a situation, the user may track completed credits through the accrediting body.

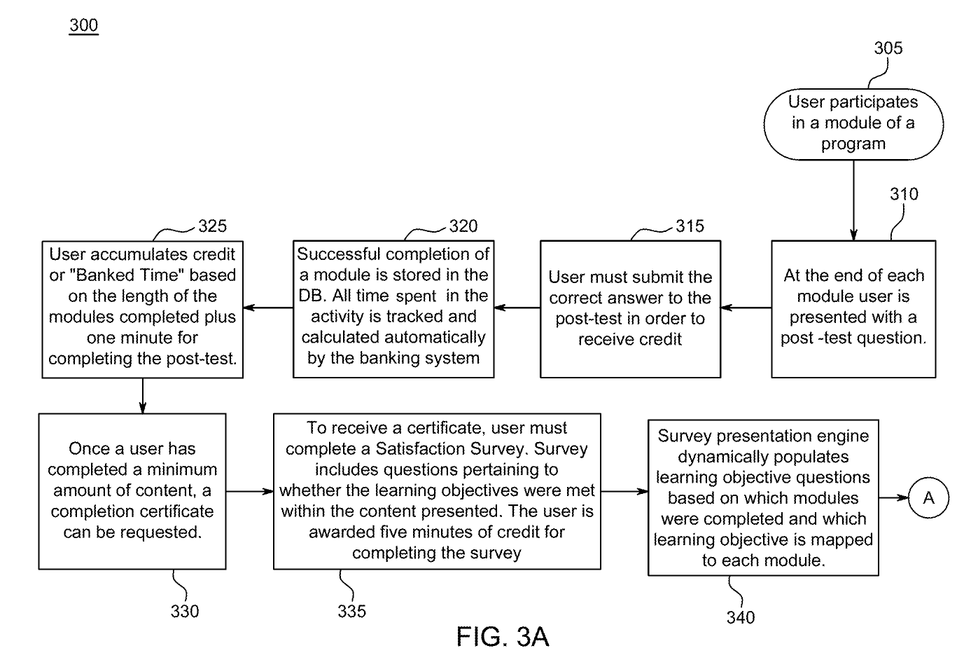

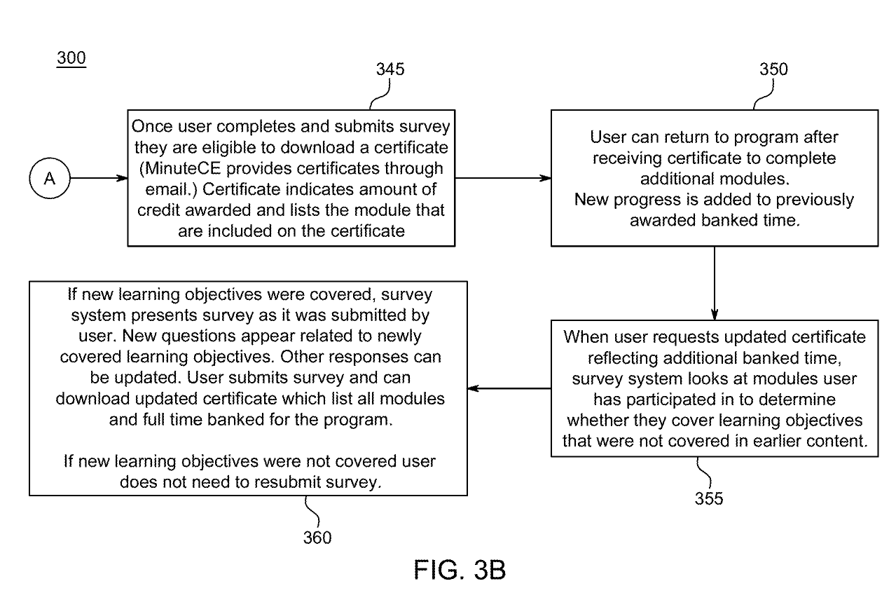

FIG. 3 illustrates a method 300 of earning credits under the rules of FIG. 2 within the system of FIG. 1. FIG. 3 refers to the collective of individual FIGS. 3A and 3B that together form FIG. 3. Method 300 may be performed within the bank system 150 of FIG. 1. Method 300 includes a defined set of learning objectives for each program. Each program is divided into distinct modules. Each of the modules in a program is mapped to a learning objective of the program. Each learning objective may be mapped to multiple modules. Module completion may be based on a multitude of factors. For example, the video playback may be tracked, and when the video completes, a post-video question may displayed to the viewer. When both the video and the post-video question are completed, the module may be tracked and identified as being completed. The user interface may also be modified to demonstrate that the module has been completed. In an implementation related to accredited CE, learning objectives may be met by the program content. CE credits are awarded based on the length of the content or time a user spends on an activity.

Method 300 begins with the system presenting a user a module of a program at step 305. At step 310, at the end of each module, the system presents the user with a post-test, also referred to as a post-video, question. At step 320, the system receives the user submission of the correct answer to the post-test question in order to receive credit. At step 325, the system accumulates the user's credit, also referred to as banked time, based on the length of the modules completed plus some additional time, for example, one minute for completing the post-test. At step 330, once a user has completed a minimum amount of content, a completion certificate can be awarded or provided by the credit system.

To receive a certificate from the credit system, a user completes a satisfaction survey, where the survey includes questions pertaining to whether the learning objectives were met within the content presented. The user may be awarded five minutes, for example, of credit for completing the survey at step 335.

At step 340, the survey presentation engine dynamically populates learning objective questions based on which modules have been completed and the learning objective mapped to that module. As set forth herein, each module may be mapped to a learning objective. Multiple modules may be mapped to the same learning objective. There is generally only one learning objective per module. When the user views the survey, logic in the present system analyzes which modules were completed by that user for the given program and selectively displays the learning objective questions that correspond to the learning objective identification that is mapped to the modules that were completed by the user.

Once a user completes and submits the survey, the system generates the certificate of completion at step 345 and may provide the certificate for download by the user. This certificate may be provided to the user via email, download or other transmission means.

The system allows the user to return to the program after receiving the certificate to complete additional modules at step 350. New progress may then be added to previously awarded banked time. When a user requests an updated certificate reflecting additional banked time, the survey system examines the modules the user has completed to determine whether the modules cover the learning objectives that were not covered in earlier content at step 355. If new learning objectives were covered by the additional modules, the survey system presents the survey as it was submitted by the user after the earlier module(s). New questions may be included based on the newly covered learning objectives. Other responses may be updated. The user submits the survey. After receiving the submitted survey, the system can provide an available download of an updated certificate which lists all of the completed modules including the newly completed modules plus the previously completed modules, and full time banked for the program modules completed at step 360 for download or other delivery. If new learning objectives were not covered in the newly completed modules, the user may not need to resubmit the survey.

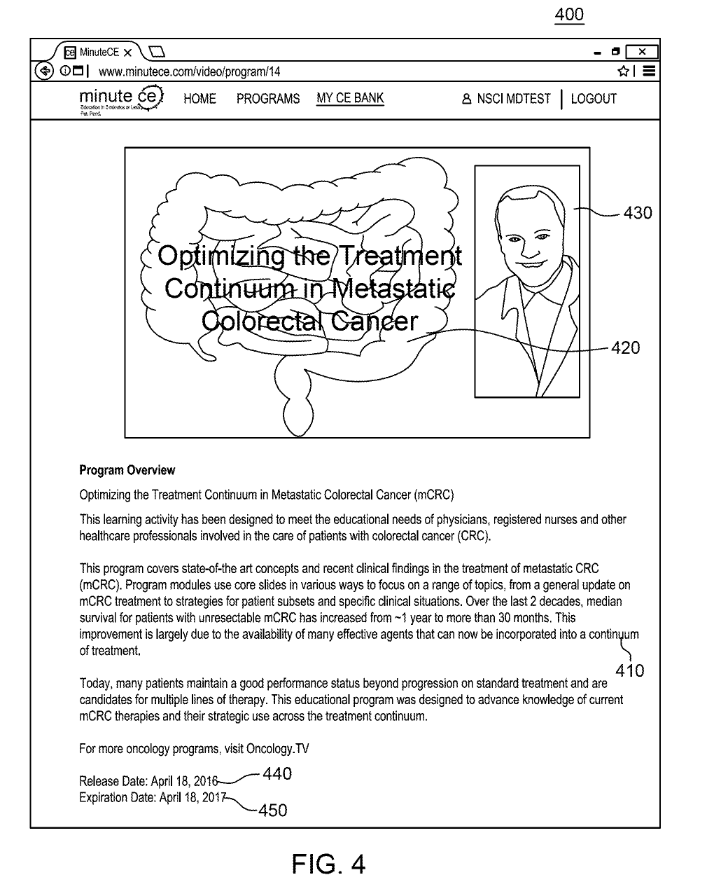

FIG. 4 illustrates a window 400 as a user utilizes the present invention to choose an educational program to view. Window 400 provides a program overview 410 of the selected educational program, the title 420 of the educational program, and the presenter 430 of the educational program. As depicted, the user may be a doctor. The release date 440 and expiration date 450 of the educational program may also be displayed within window 400.

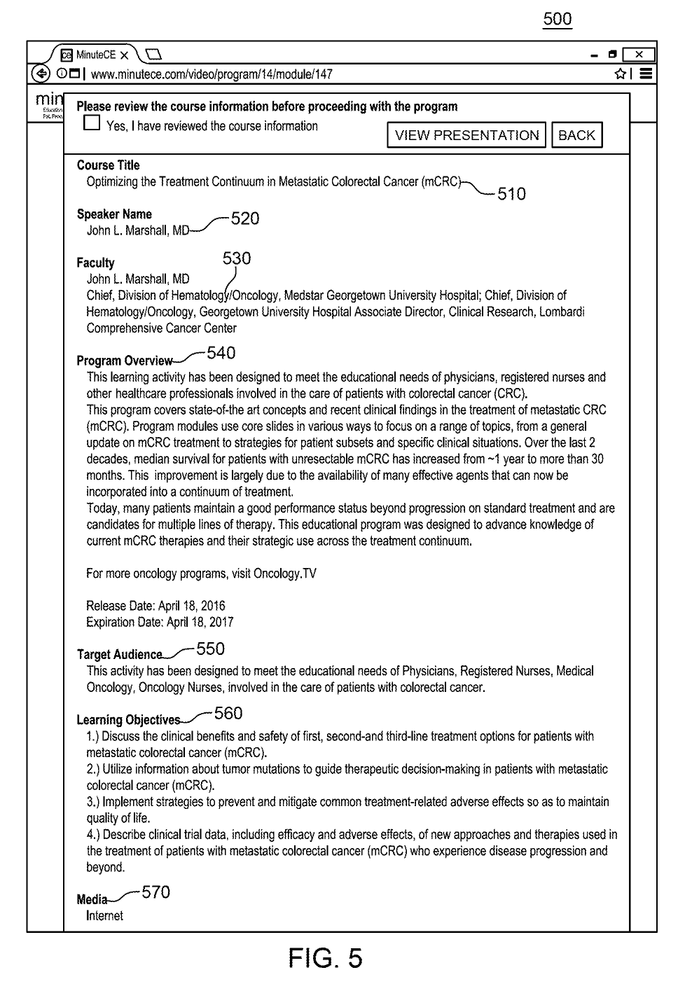

FIG. 5 illustrates a window 500 that presents the user with the “front matter,” the material that describes the educational program and the requirements for completion. In an implementation, the present system may be designed to require the user to acknowledge the front matter in order to comply with CE accreditation, for example. The front matter may include a course title 510 of the selected educational program, the name of the speaker 520 of the educational program, faculty 530 associated with the educational program, the program overview 540, the target audience 550 for the educational program, the learning objectives 560 of the educational program and the media 570 of the educational program.

By way of non-limiting example only, the target audience 550 may include the educational needs of physicians, registered nurses, medical oncology, oncology nurses involved in the care of patients with colorectal cancer. Other target audiences include audiences or groups of people that require on-going accreditation or other types of continuing education.

By way of non-limiting example only, the learning objectives 560 may include (1) discussing the clinical benefits and safety of first, second and third-line treatment options for patients with metastatic colorectal cancer, (2) utilizing information about tumor mutations to guide therapeutic decision-making in patients with metastatic colorectal cancer, (3) implementing strategies to prevent and mitigate common treatment-related adverse effects so as to maintain quality of life, and (4) describing clinical trial data, including efficacy and adverse effects, of new approaches and therapies used in the treatment of patients with metastatic colorectal cancer who experience disease progression and beyond. Program objectives are linked to the modules and the overall program objectives as described herein.

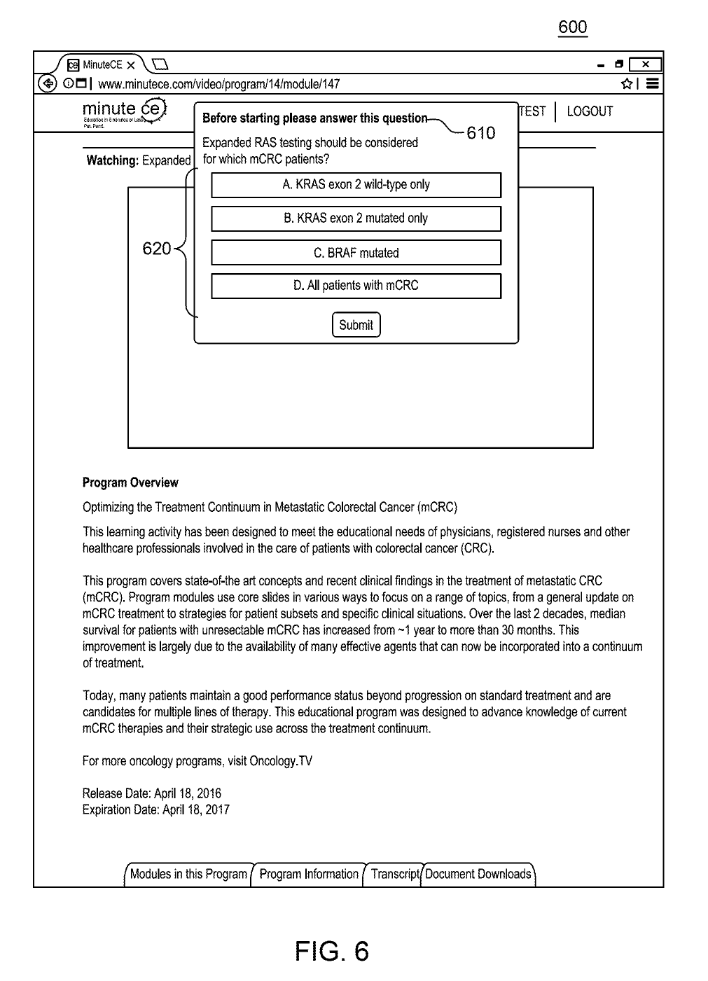

FIG. 6 illustrates a window 600 provided to the user prior to viewing the module. For example, prior to viewing the module the user may be presented with a pre-video quiz question 610. Four answers 620 may be available for user selection. The user selects the answer from the four answers 620 believed to be correct and submits the response. For the pre-video quiz the user may not receive feedback about their submission. The system records the response.

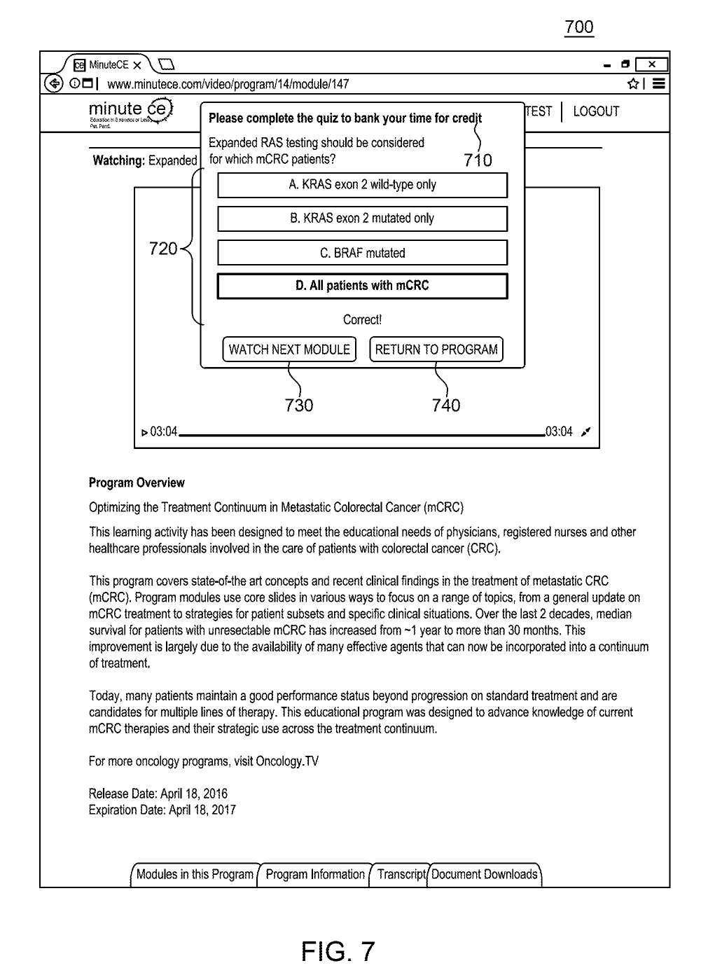

FIG. 7 illustrates a window 700 provided to the user after viewing the module. For example, after viewing the module the user may be presented with a post-video quiz question 710. Four answers 720 may be available for user selection. This question may be the same question as the pre-video quiz question 610, although the post-video quiz question 710 may be different from the pre-video quiz question 610. The user selects and submits the answer they believe to be the correct answer. If the answer is incorrect, the user receives feedback and continues attempting to answer the question correctly before credit for the module is awarded. In an implementation, the first answer submitted by the user is recorded. Once the user submits the correct response to the post-video quiz question, they are shown feedback and given the option to view another module 730 or return to the program 740.

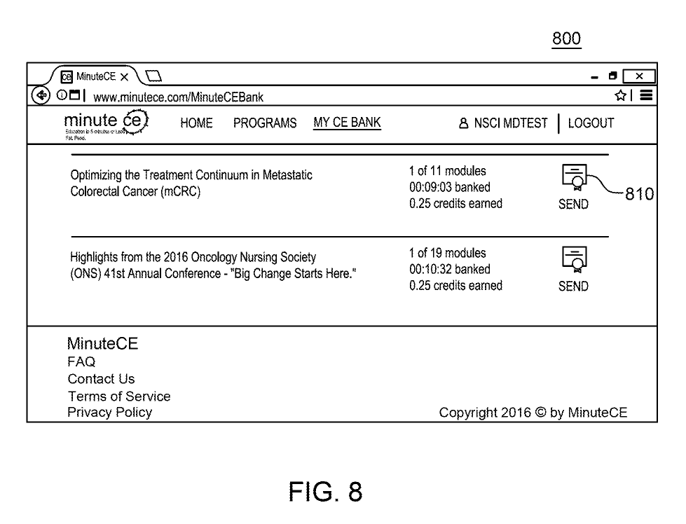

FIG. 8 illustrates a window 800 that allows the user to interact with the banking system. If at this point the user were to view the banking system they are shown credits 810 they have completed and the amount of credit award, if any. In this case the user has completed 1 of 11 modules and has been awarded ¼ credit hours. In an implementation, the bank system awards credit based on the length of the viewed module plus 1 minute per module for participating in the pre/post quiz. Additionally, the user is awarded 5 minutes of time for completing the satisfaction survey (typically required for online CE participation). In an example situation, the module length is 3:03. This gives the user a total of 9:03 minutes of credit. This amount is rounded up to the nearest quarter hour. In this case the user is awarded ¼ credit hours.

Accrediting organizations determine the increments users are allowed to receive credit. In an implementation, doctors are allowed to receive credit in 0.25 hour increments while nurses receive credit in 0.5 or total hour increments. In this implementation, if the user were a nurse, the system would indicate no credit to have been awarded yet because 9:03 minutes rounded up to the nearest quarter hour is less than 0.5 needed to receive credit. If the nurse were to try to apply for credit by completing the satisfaction survey they would receive a message indicating they need to complete more modules to be eligible for a certificate.

Since the user in this example is a doctor they are awarded 0.25 credit hours and can request a certificate for their participation.

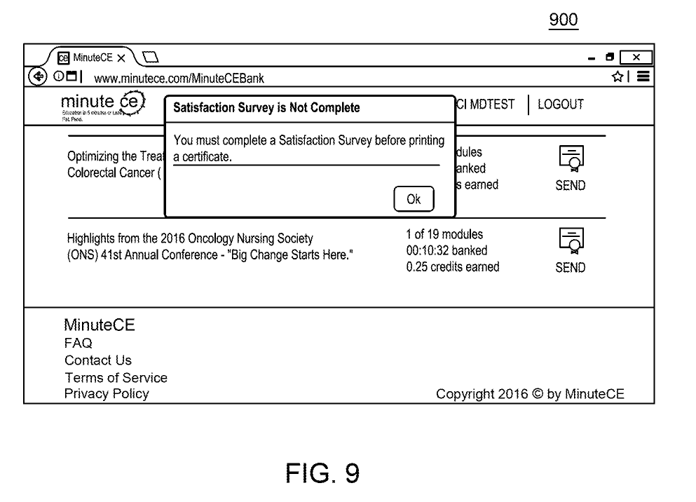

To be awarded credit the user completes the satisfaction survey. As shown in FIG. 9, this illustrates a window 900 indicating that the user needs to complete the survey.

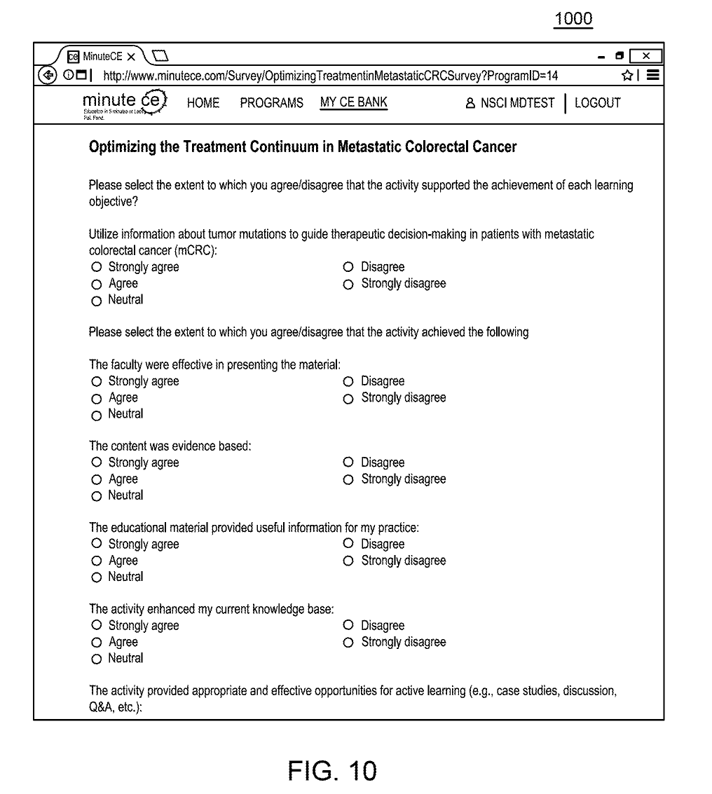

FIG. 10 illustrates a window 1000 that is presented to the user based on the modules viewed. Each module is mapped to a learning objective specified for the program. There are questions in the satisfaction survey that ask whether the program met the specified learning objectives. Since the user may not have been exposed to content that addresses the entire program learning objectives, the survey is customized programmatically to display those learning objective questions for which the user has viewed learning material. In the example, the user has only been exposed to one learning objective. The specific question regarding this learning objective is displayed at the top of the survey. The survey may request information from the user by querying about the extent the user agrees that the module supported the achievement of the associated learning objective. One example of a specific question illustrated in FIG. 10 is how strongly do you agree that the information about tumor mutations to guide therapeutic decision-making in patients with metastatic cancer (mCRC). The survey may further request additional information about the faculty and the ability to present the materials, how useful the module was to the user's practice or job, and the enhancement the user received by viewing the module.

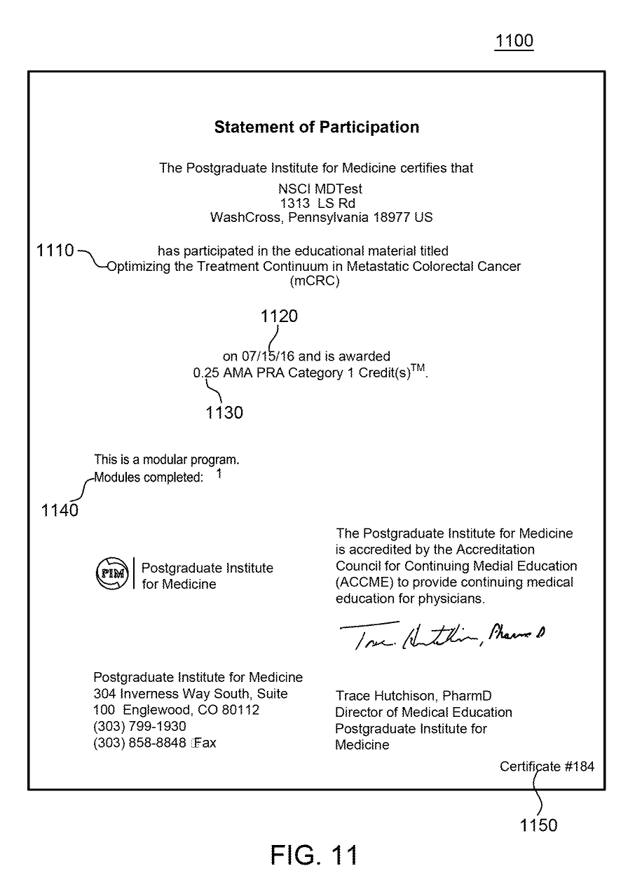

Once the survey is completed and submitted the user can generate a certificate. FIG. 11 illustrates a window 1100 depicting the certificate. The certificate is dynamically generated for this user and reflects the viewed program 1110, the date 1120, credit awarded 1130 and the modules that the user participated in to earn credit 1140. A certificate number 1150 is shown in window 1100.

At this point the user can choose to continue banking additional credit by watching more modules from the program. They may experience a similar flow as described above as they progress through additional modules. Each module starts with a pre-video quiz question. They watch the video and answer the post-video quiz question.

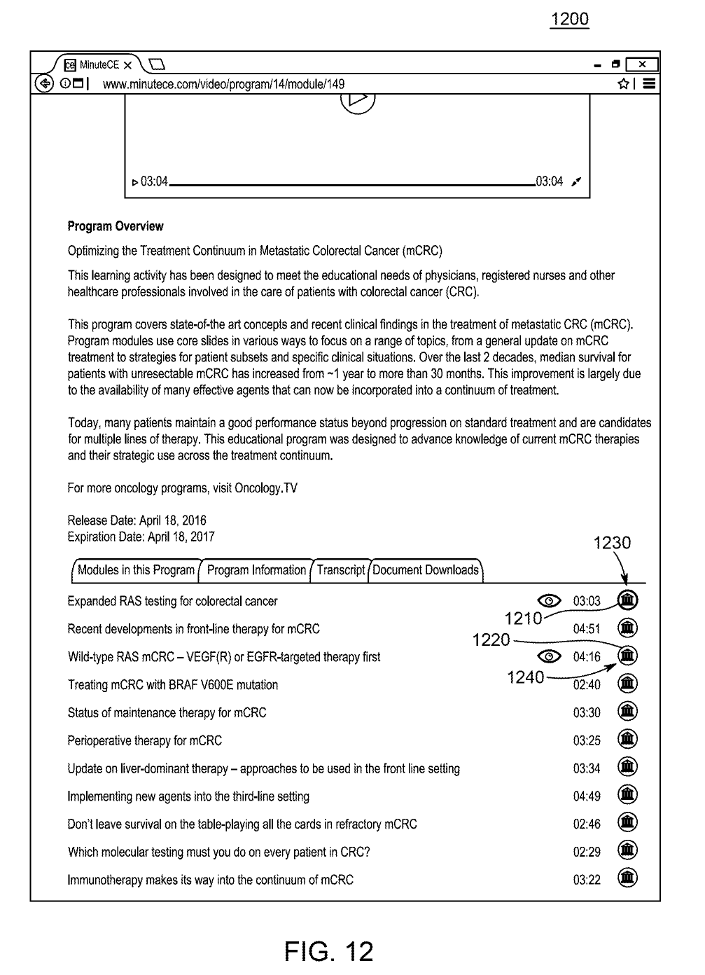

Throughout the process the user interface tracks and displays what the user has completed within the module. FIG. 12 illustrates a window 1200 displaying the modules within the program selected by providing information regarding viewed modules and credited modules. Within window 1200 module 1 1210 and module 3 1220 have been viewed by the user. Module 1 1210 has been awarded for credit as depicted with icon 1230. Module 3 1220 has not been awarded credit as depicted with icon 1240. Icon 1240 indicates the user didn't submit a response to the post-video quiz question for module 3 1220.

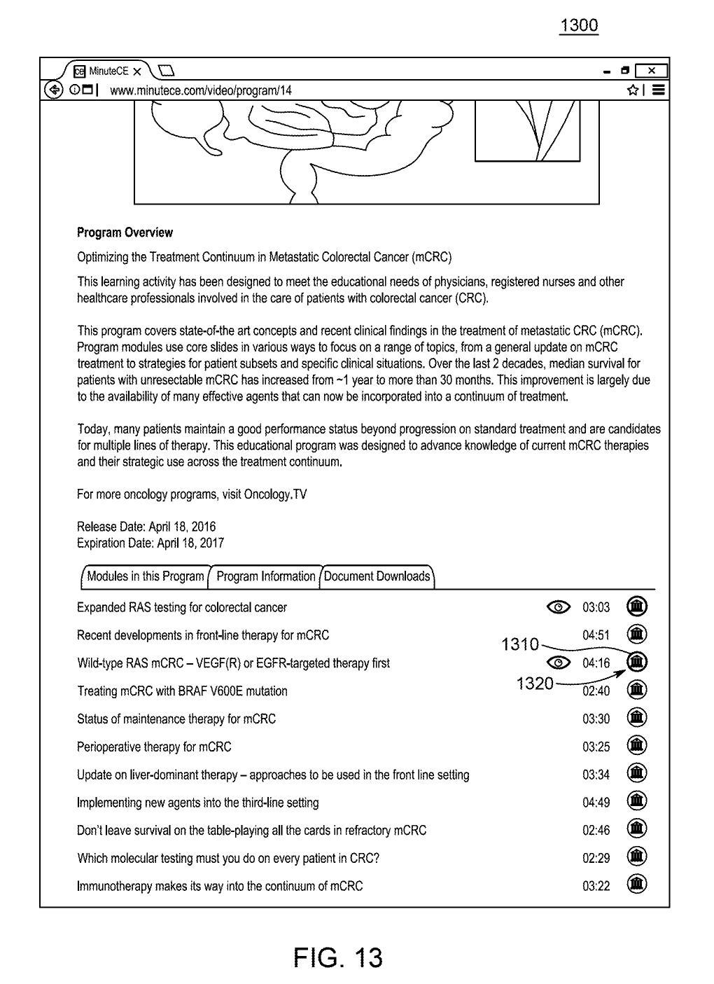

FIG. 13 illustrates a window 1300 updated from window 1200 once the quiz question response has been submitted. Module 3 1310 has a completed quiz question and credit has been received. Icon 1320 has been updated to reflect that credit has been awarded for module 3 1310.

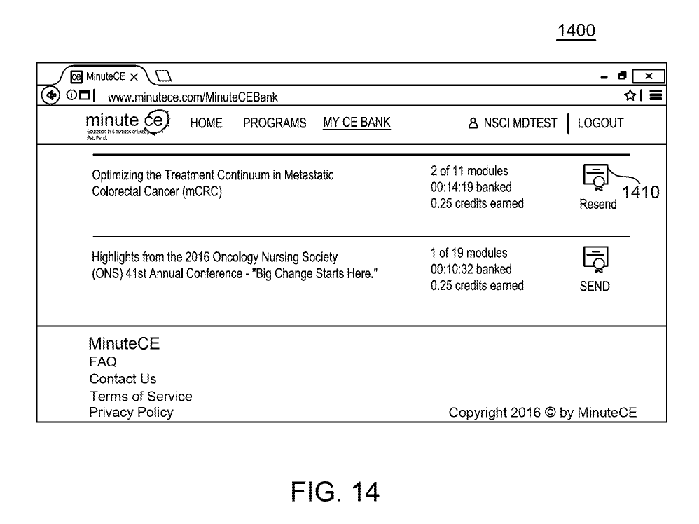

FIG. 14 illustrates a window 1400 that depicts the banking system discussed above with respect to FIG. 8. Upon returning to the banking system, window 1400 depicts that the user has completed 2 modules out of 11. The total time banked has increased (14:19) but the total credits awarded have not (0.25).

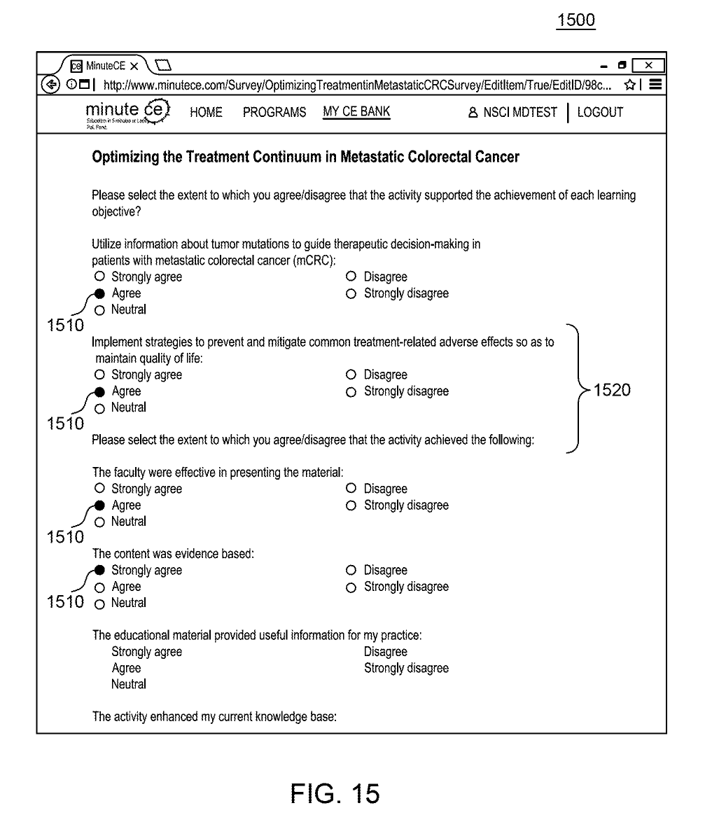

FIG. 15 illustrates a window 1500 that allows the user to interact with the banking system updated from window 1000. Window 1500 includes the progress that module 3 has been completed. Credit is not ready to be awarded for module 3 because the survey needs to be updated with the learning objective from module 3. Module 3 covers a different learning objective than module 1 so if the user attempted to get a certificate again they will be notified the survey needs to be updated. Upon returning to the satisfaction survey they would be presented with the survey populated with their previous answers 1510 submitted earlier in response to window 1000. Window 1500 includes an additional question 1520 that pertains to the newly covered learning objective. The user may answer additional question 1520 and resubmit the form to get a revised certificate.

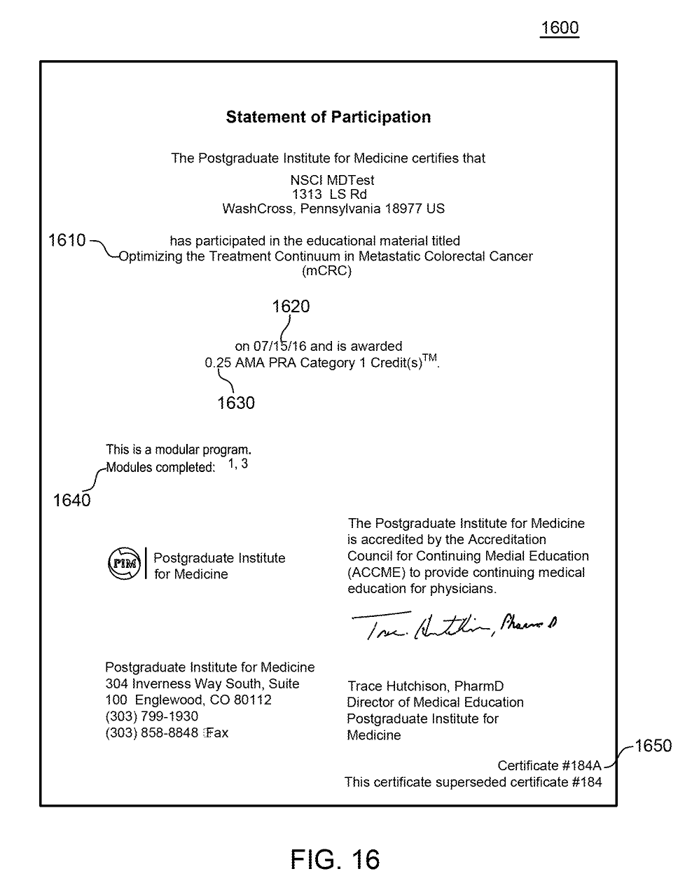

Once the survey is completed and submitted the user can generate a certificate. FIG. 16 illustrates a window 1600 depicting the updated certificate of window 1100. Again the certificate is dynamically generated for this user and reflects the viewed program 1610, the date 1620, credit awarded 1630 and the modules that the user participated in to earn credit 1640. A certificate number 1650 is shown in window 1600. In an implementation, as compared to window 1100, window 1600 includes an updated module list 1640 and a new certificate number 1650. Window 1600 may further include that the new certificate number 1650 supersedes the certificate number (1150) of window 1100.

In general and without limiting embodiments described herein, a computer readable non-transitory medium including instructions which when executed in a processing system cause the processing system to execute a method for mobile education.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system for accruing credits to satisfy continuing education requirements, the accrual occurring by banking earned credits until a threshold of credits is met, the system comprising:
a plurality of curricula that are viewed to earn continuing education credits, each of the plurality of curricula having a defined credit value associated therewith and each of the plurality of curricula being divided into one or more segments, each of the segments corresponding to a partial degree of credit;
a plurality of learning objectives associated with each of the plurality of curricula with each of the one or more segments being directed to one of the plurality of learning objectives;
at least one survey corresponding to each of the plurality of learning objectives, the at least one survey being completed by user after the user views at least one segment directed to the corresponding learning objective in order to verify the completion of the at least one segment and fulfillment of the corresponding learning objective and award the earned credit corresponding to the partial degree of credit corresponding to the viewed segment;
a banking system for capturing the earned credit based on completed segments, the banking system accruing the earned credit until a minimum threshold of credit is met; and
a credit system that once the threshold is met seeks credit for the accrued earned credit by transmitting a request for credit to the appropriate certification organization to award the earned credit to the user.

2. The system of claim 1 wherein the plurality of curricula is viewed by at least one user connected to the system via a communication network.

3. The system of claim 2 wherein the at least one user uses a phone, personal digital assistant, tablet, laptop, or desktop computer to access the system.

4. The system of claim 1 wherein the one or more segments are approximately 5 minutes or less in length.

5. The system of claim 1 wherein the one or more segments average less than 5 minutes in length.

6. The system of claim 1 wherein the threshold for requesting credit is one half credit.

7. The system of claim 1 wherein the threshold for requesting credit is a full credit.

8. The system of claim 1 wherein 5-10 modules combine to meet the threshold for requesting credit.

9. The system of claim 1 wherein 10-20 modules combine to meet the threshold for requesting credit.

10. A method for accruing credits to satisfy continuing education requirements, the accrual occurring by banking earned credits until a threshold of credits is met, the method comprising:
viewing a plurality of programs to earn continuing education credits, each of the plurality of programs having a defined credit value associated therewith and each of the plurality of programs being divided into one or more modules, each of the modules corresponding to a partial level of credit;
associating a plurality of learning objectives with each of the plurality of programs, with each of the one or more modules being directed to one of the plurality of learning objectives;
correlating at least one survey to each of the plurality of learning objectives, the at least one survey being completed by user after the user views at least one module directed to the corresponding learning objective in order to verify the completion of the at least one module and fulfillment of the corresponding learning objective and award the earned credit corresponding to the partial level of credit corresponding to the viewed module;
capturing, via a banking system, the earned credit based on completed modules, the banking system accruing the earned credit until a minimum threshold of credit is met; and
seeking credit, via a credit system, once the threshold is met, for the accrued earned credit by transmitting a request for credit to the appropriate certification organization to award the earned credit to the user.

11. The method of claim 10 wherein the one or more modules are approximately 5 minutes or less in length.

12. The method of claim 10 wherein the one or more modules average less than 5 minutes in length.

13. The method of claim 10 wherein the threshold for requesting credit is one half credit.

14. The method of claim 10 wherein the threshold for requesting credit is a full credit.

15. The method of claim 10 wherein 5-10 modules combine to meet the threshold for requesting credit.

16. The method of claim 10 wherein 10-20 modules combine to meet the threshold for requesting credit.

17. A method of earning credits, the method comprising:
monitoring the completion of one of a plurality of modules derived from an accredited program;
at the completion of one of the plurality of modules, presenting a question derived from the learning objective associated with the completed one of the plurality of modules;
verifying the response to the presented question; and
upon positive verification, storing the credit value associated with the completed one of the plurality of modules in a banking system.

18. The method of claim 17, further comprising aggregating the stored credit value for a series of completed ones of the plurality of modules until a minimum threshold is achieved.

19. The method of claim 18 wherein once the minimum threshold is achieved, the method further comprising issuing a certificate of completion for the amount of aggregated stored credit values.

20. The method of claim 18 wherein once the minimum threshold is achieved, the method further comprising submitting the amount of aggregated stored credit values to an accreditation agency.
